(19) United States
(12) Patent Application Publication
(10) Pub. No.: US 2005/0046137 A1
(43) Pub. Date: Mar. 3, 2005

(54) Hydraulic suspension device and system for controlling wheel hop

(76) Inventor: Fima Dreff, Toronto (CA)

Correspondence Address: DENNISON ASSOCIATES, 133 RICHMOND STREET WEST, SUITE 301, TORONTO, ON, M5H 2L7, CA

(21) Appl. No.: 10/649,605

(22) Filed: Aug. 28, 2003

(51) Int. Cl. B60G 1/00

(52) U.S. Cl. 280/124.157

(57) ABSTRACT

A vehicle wheel suspension arrangement includes two long stroke vibration damping systems to reduce vibration associated with wheel hop and tramp mode. Each system is tailored to address the problem frequency bands and the systems preferably operate independently. In a preferred embodiment, the systems are placed in parallel. Each long stroke vibration damping system accommodates relatively large displacements associated with vehicle wheel suspension displacements associated with frequencies of less than 25 Hz. In a preferred embodiment, one vibration damping system is a shock absorber and the other vibration damping system _works on hydromount principles and is capable of narrow (tunable) frequency band damping.

This application claims priority of and is related to U.S. Provisional Application entitled HYDRAULIC SUSPENSION DEVICE AND SYSTEM FOR CONTROLLING WHEEL HOP filed Jun. 20, 2003.

### BACKGROUND OF THE INVENTION

The present invention relates to suspension arrangements and in particular to suspension arrangements, which can provide tuned damping capable of handling large displacements.

Existing vehicle wheel suspension arrangements include a strut and/or damper, which are both commonly referred to as a shock absorber. The shock absorber is used to attenuate both the low frequency ride modes, which are generally at frequencies less than 2 Hz, and the higher frequency wheel hop and tramp modes, which are typically in the range of 10-15 Hz.

Wheel hop and tramp mode energy can cause vehicle shake, which is a significant issue for the automotive industry. It is common to tune the shock absorbers by use of orifice size and blow-off valves to affect the frequency above which damping diminishes. The shocks can be tuned such that the damping is maintained up to the wheel hop/trap mode frequencies. This arrangement provides some wheel hop/tramp energy dissipation, however, the attenuation may not be sufficient. Also, this system tends to transmit high frequency vibration that leads to road noise concerns.

In some cases, hydraulic damping is added to the system by the use of powertrain hydromounts. These hydromounts are often tuned such that they assist in reducing the wheel hop/tramp energy. This design is not very effective at attenuating the wheel hop/tramp mode energy because the mounts are not in the direct energy flow path from the wheel to the passenger. Furthermore, hydromounts tuned in this manner are not optimal for attenuating powertrain modes and also allow more high frequency powertrain vibration into the vehicle.

Another existing arrangement utilizes the powertrain as a tuned absorber for the wheel hop/tramp modes by choosing powertrain mount stiffnesses so that the powertrain bounce mode coincides with the wheel hop/tramp frequencies. This design constraint leads to mounts having a much higher stiffness than is necessary for controlling powertrain motion and reduces the effectiveness of the mount to isolate high frequency transmission.

It is also known to use hydraulic damping of the type generally used for powertrain mounts to damp wheel hop/tramp frequencies in the form of hydraulic strut mounts. In this case, the hydromounts are placed in series with the shock absorbers, but the arrangement is not totally effective due to the large displacements associated with wheel hop.

The present invention seeks to overcome the various compromises that have been made in the prior art designs associated with the vehicle wheel suspension arrangements and additionally, to provide a long stroke hydraulic tuned damper that can be used in a number of different applications.

### SUMMARY OF THE INVENTION

A vehicle wheel suspension arrangement, according to the present invention comprises a first long stroke vibration damping system, and a second long stroke vibration damping system, where each long stroke vibration damping system is tuned to operate at different frequencies. The first, long stroke vibration system is tuned to attenuate low frequencies associated with a ride mode. The second, long stroke vibration damping system is tuned to attenuate higher frequencies associated with a wheel hop and tramp mode. Each long stroke vibration system is specifically designed to operate over a limited frequency band associated with the specific vehicle mode.

According to an aspect of the invention, the first long stroke vibration damping system includes a blow off valve limiting the attenuation characteristics to a frequency less than 5 Hz. According to a further aspect of the invention, the first and second long stroke vibration damping systems are placed in parallel with one another.

In yet a further aspect of the invention, the second long stroke vibration damping system is designed to attenuate a specific frequency band in the range of 10 to 25 Hz.

In yet a further aspect of the invention, each long stroke vibration damping system is designed to be effective in a narrow frequency band and the frequency bands are separate and distinct.

In a further aspect of the invention, the second long stroke vibration damping system is a long stroke hydromount arrangement.

In yet a further aspect of the invention, the hydromount arrangement includes an elongated piston cylinder closed at one end by a deformable diaphragm, a piston movable within the cylinder and defining within said cylinder a variable volume chamber between said piston and said diaphragm and an inertia track connecting said working chamber to a fluid collection chamber. A working hydraulic fluid is displaced through said inertia track and into or out of said fluid collection chamber with movement of said piston.

In yet a further aspect of the invention, the hydromount arrangement is designed to accommodate displacements of at least 25 mm.

In a further aspect of the invention, the first and second vibration damping systems are combined in a single structure with the vibration damping systems being generally concentric.

In a further aspect of the invention, the first and second vibration damping systems are combined and disposed in a parallel configuration.

In a further aspect of the invention, an orifice and channel in the piston act as the inertia track, and the volume of the cylinder above the piston forms the fluid collection chamber.

In a further aspect of the invention, the first and second vibration damping systems are integrated into a combined vibration damping system.

In another aspect of the invention, the long stroke hydraulic tuned damper is located in parallel with the steering system and tuned to damp steering nibble (previous examples tuned to address wheel hop). Steering nibble is the oscillating rotational motion of the steering wheel aggravated by the suspension modes.

In an aspect of the invention, the limited frequency band associated with ride mode is separated from said limited frequency band associated with wheel hop and tramp mode by an intermediate frequency band.

In yet a further aspect of the invention, each of the first and second vibration damping systems have little effect on the intermediate frequency band.

### BRIEF DESCRIPTION OF THE DRAWINGS

Preferred embodiments of the invention are shown in the drawings, wherein:

FIG. 1 is a sectional view through a known hydromount;

FIG. 2 is a sectional view though a known hydromount of alternate construction;

FIG. 3 is a schematic view showing a vehicle wheel suspension arrangement;

FIG. 4 is a schematic of the vehicle wheel suspension arrangement having the first and second long stroke shock absorbing systems;

FIG. 5 is a sectional view through the long stroke hydraulic tuned damper;

FIG. 6a is a sectional view through the long stroke hydraulic tuned damper of an alternate construction;

FIG. 6b is a sectional view through the long stroke hydraulic tuned damper of another alternate construction;

FIGS. 7a through 7d show the frequency damping characteristics of different shock absorbing systems;

FIG. 8 is a frequency transmissibility curve of the vehicle wheel suspension arrangement;

FIG. 9 is a schematic view of the hydraulically tuned damper in combination with a shock absorber disposed in a parallel relationship;

FIG. 10 is a view similar to FIG. 9 with the long stroke hydraulic tuned damper disposed in a concentric manner with the shock absorber; and

FIG. 11 is a schematic view of the long stroke hydraulic tuned damper arranged in parallel with the vehicle steering system.

### DETAILED DESCRIPTION OF THE PREFERRED EMBODIMENTS

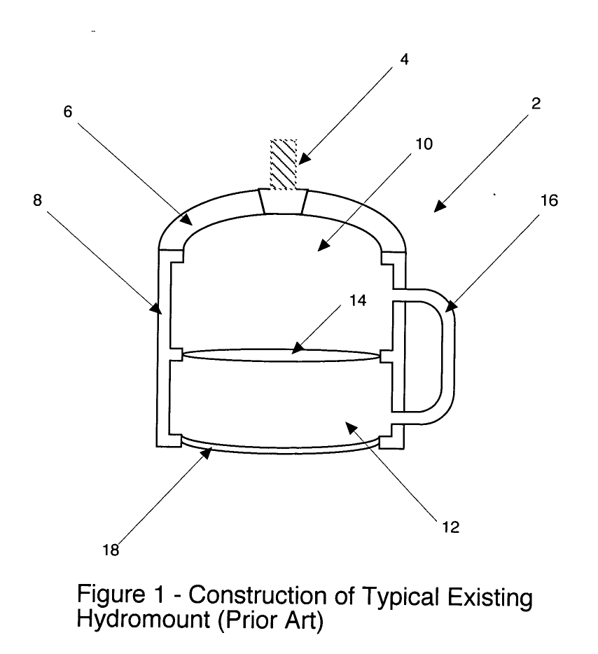

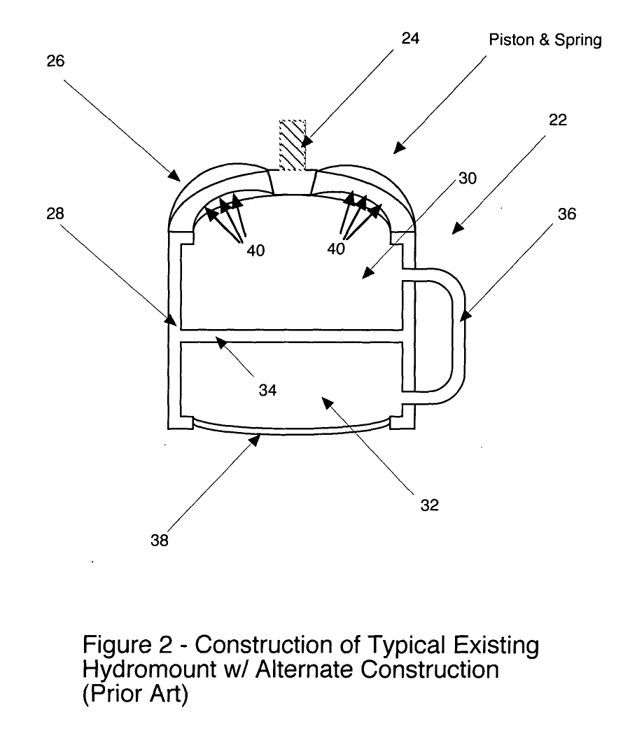

FIGS. 1 and 2 show examples of prior art hydromounts which are commonly used in the automotive industry as powertrain mounts. These hydromounts are designed to operate with relatively low displacement values in the order of approximately 1 mm. The hydromount (2) shown in FIG. 1 includes a mounting stud supported within the rubber shoulders (6). These rubber shoulders have a sealed relationship with the metal housing (8) and close one end of the housing. The housing is divided by the deformable diaphragm (14) and forms an upper hydraulic chamber (10) and a lower hydraulic chamber (12). These hydraulic chambers are connected by the inertia track (16). The lower end of the hydromount (2) is sealed with an expandable bellows (18).

With this arrangement, the rubber shoulders (6) effectively act as a piston with the load being transmitted to the upper chamber (10). The additional pressure on the hydraulic fluid within the upper chamber causes fluid to flow through the inertia track (16). The inertia track (16) is designed such that the mass of the fluid in the inertia track is scaled up to act as a large effective mass. In addition, the hydraulic fluid can cause deformation of the deformable diaphragm (14). It is the combination of the movement through the inertia track (16) and the distortion of the deformable diaphragm (14) that provides the tunable response characteristics of the hydromount. As can be appreciated, the mounting stud (4) can apply a downward pressure on the shoulders (6) which requires a displacement of the hydraulic working fluid in the upper chamber (10) which also causes an effect on the hydraulic fluid in the lower chamber (12). Fluid is forced though the inertia track into the lower chamber (12) and some deformation of the diaphragm (14) occurs to partially offset the immediate requirement for displacement of the hydraulic fluid. Any necessary expansion of the lower chamber (12) occurs due to the expandable bellows (18).

The alternate hydromount (22) of FIG. 2 again includes a mounting stud (24), rubber shoulders (26), a housing (28) and an inertia track (36). In this case, the housing (28) is divided by a solid partition (34) and an expandable bellows (38) closes the lower chamber (32). In this structure, the rubber shoulders (26) also allow for some distortion (40) to expand the volume of the upper chamber (30). This distortion fulfills the same function as the diaphragm in the previously described hydromount.

The hydromounts of FIGS. 1 and 2 are commonly used to damp the vibration introduced by the powertrain components and have also been used in series with a traditional shock absorber for helping to attenuate wheel hop frequencies transmitted by the wheels to the powertrain components.

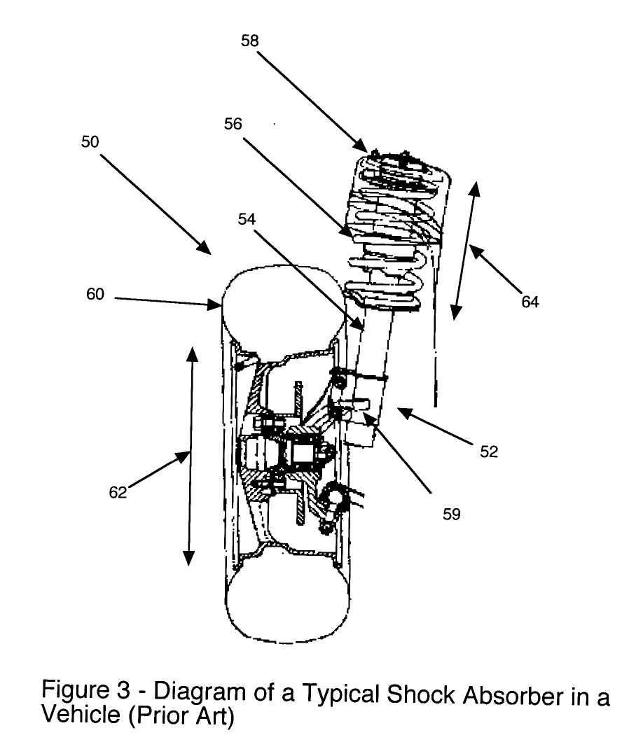

FIG. 3 illustrates a common vehicle wheel assembly (5) having a vehicle wheel suspension arrangement (52). This suspension arrangement includes the shock absorber (54), the suspension spring (56), a vehicle attachment position (58) and a wheel attachment position (59). The vehicle wheel (60) is exposed to displacement generally indicated as (62). This wheel displacement (62) is partially damped by the vehicle wheel suspension arrangement (52), such that this suspension arrangement undergoes a certain displacement indicated as (64). Although some of the energy of the wheel displacement (62) has been damped by the suspension arrangement (52), the suspension arrangement does transmit forces to the passenger compartment, especially at the higher frequencies related to wheel hop and road noise.

The vehicle wheel suspension arrangement, as shown in FIG. 3, having the traditional shock absorber (54), can be designed to strictly deal with ride mode frequencies, such as frequencies below 2 Hz. In this case, the shock absorber includes a blow off valve, such that the shock absorber is effectively inoperative at frequencies above 2 Hz. It is also known to use this type of vehicle wheel suspension arrangement where the blow off valve is set at about 15 Hz. In this case, the suspension arrangement damps both ride mode frequencies and wheel hop and tramp mode frequencies of 10-15 Hz. This second arrangement unfortunately, transmits more high frequency force, leading to road noise.

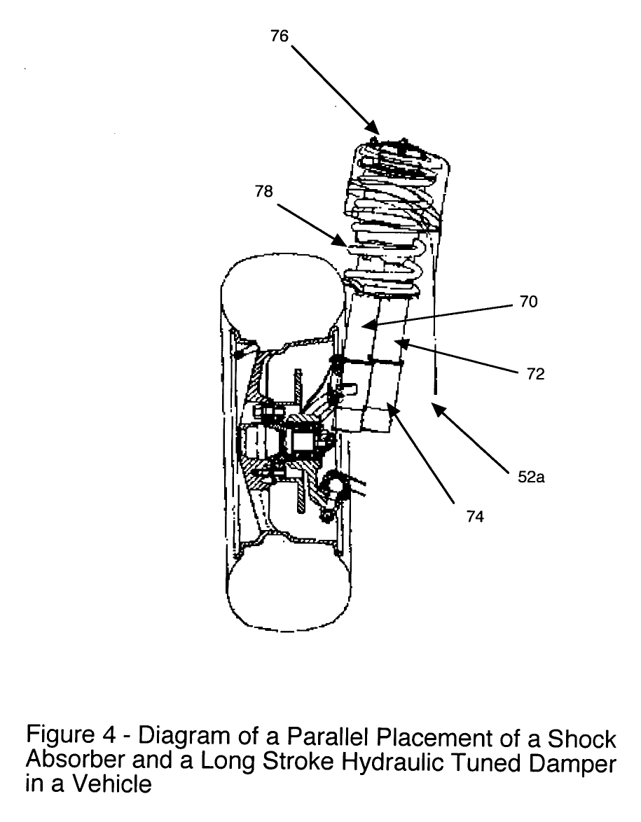

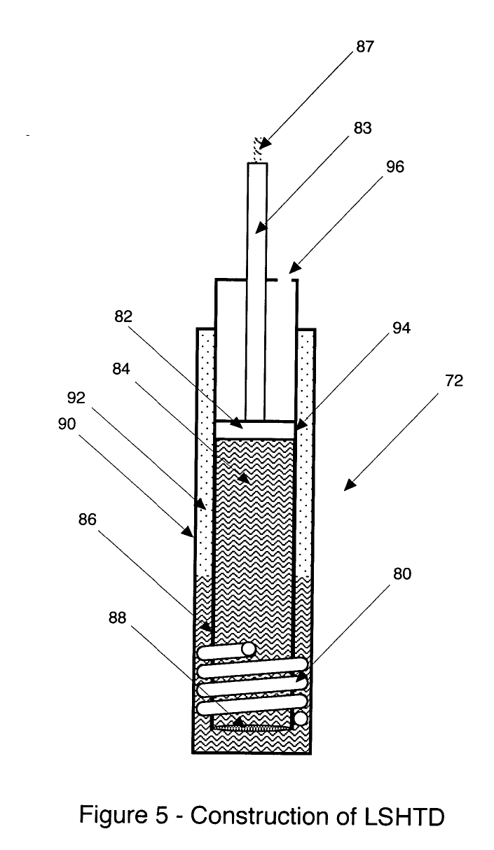

A modified vehicle wheel suspension arrangement (52a) is shown schematically in FIG. 4. This suspension arrangement includes a shock absorber (70) in combination with a long stroke hydraulic tuned damper (72). Both the shock absorber (70) and the long stroke hydraulic tuned damper (72) are connected and disposed between the vehicle body attachment (76) and the wheel attachment (74). In addition, the suspension arrangement includes the suspension springs (78). The long stroke hydraulic tuned damper (72) is shown in greater detail in FIG. 5.

The long stroke hydraulic tuned damper (72) is designed to accommodate much greater displacements relative to the hydromounts of FIGS. 1 and 2. This system accommodates displacements greater than 25 mm and this is primarily due to the cylinder type design and the movable piston (82). Piston (82) is movable within the working cylinder (86), which has a deformable diaphragm (88) at the closed end of the cylinder. The piston applies pressure against the working fluid (84) and causes movement of the working fluid through the inertia track (80). Thus, the working fluid is free to move through the inertia track (80) between the working cylinder (86) and the collection chamber (90). A low-pressure gas (92) expands and contracts in accordance with the amount of working fluid in the collection chamber. The piston (82) includes piston seals (94). The cylinder (86) is closed on the opposite side of the piston (82) but allows the piston rod (83) to move through the closed end. A vent (96) is provided to accommodate movement of the piston (82). The piston rod (83) includes a fastening mechanism to attach to the vehicle (87).

The inertia track (80) connects the working cylinder (86) with the collection chamber (90), which is effectively an exterior cylinder. The length of the inertia track and the size thereof effectively determines the characteristics of the long stroke hydraulic tuned damper. The deformable diaphragm (88) works in a similar manner to the deformable diaphragm of the hydromounts of FIG. 1. As with traditional hydromounts, this system can be tuned to attenuate energy in specific frequency ranges.

Returning to FIG. 4, it can be appreciated that the shock absorber (70) can include a blow off valve, such that the shock absorber is effective at frequencies less than about 5 Hz and preferably less than about 2 Hz. The long stroke hydraulic tuned damper is designed to operate within a frequency band higher than the upper limit of the shock absorber. The tuned damper operates in a frequency band of greater than 5 Hz and less than 25 Hz. A frequency band of 10 to 25 Hz is effective, although the preferred frequency band is 10 to 15 Hz. Thus, the tuned damper (72a) and the shock absorber (70) operate in separate and distinct frequency bands and are preferably separated by an intermediate frequency band between about 5 Hz and less than 10 Hz. These frequency bands can change to address specific applications associated with the vehicle suspension arrangement and allow the designer to tailor each system to address a particular vibration mode. In this way, the suspension system has been designed to be effective at two different ranges without the covering the entire frequency range between 0 and the upper frequency of 15 Hz. This combination vehicle wheel suspension arrangement can be designed to address the particular frequency ranges of importance. Furthermore, the suspension arrangement is also useful in other applications.

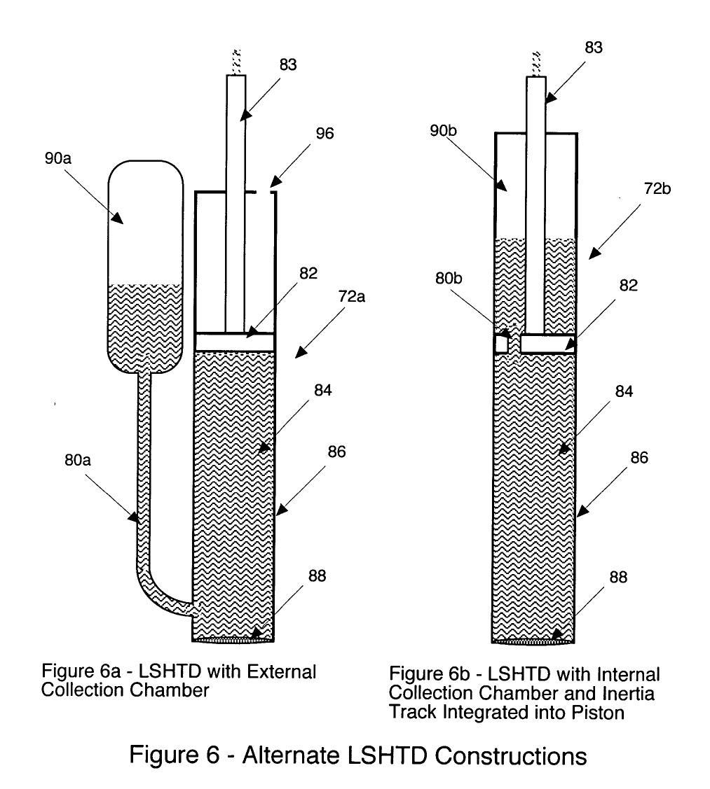

FIG. 6a shows an alternate long stroke hydraulic tuned damper (72a), which has the piston (82) operating within the working cylinder (86). The diaphragm (88) closes one end of the cylinder and the inertia track (80a) now joins the working cylinder (86) with the collection chamber (90a). The system effectively operates in the same manner where the piston (82) acts on the working fluid (84) and the response characteristics of the damper are a function of the diaphragm (88) and the inertia track (80a).

FIG. 6b shows another alternate long stroke hydraulic tuned damper (72b), which also has the piston (82) operating within the working cylinder (86). An orifice and channel in the piston perform the function of the inertia track (80b). Similarly, the volume of the cylinder above the piston performs the function of the collection chamber, which also contains the low-pressure gas (90b). The diaphragm (88) closes one end of the cylinder. This system also effectively operates in the same manner where the piston (82) acts on the working fluid (84) and the response characteristics of the damper are a function of the diaphragm (88) and the inertia track (80b).

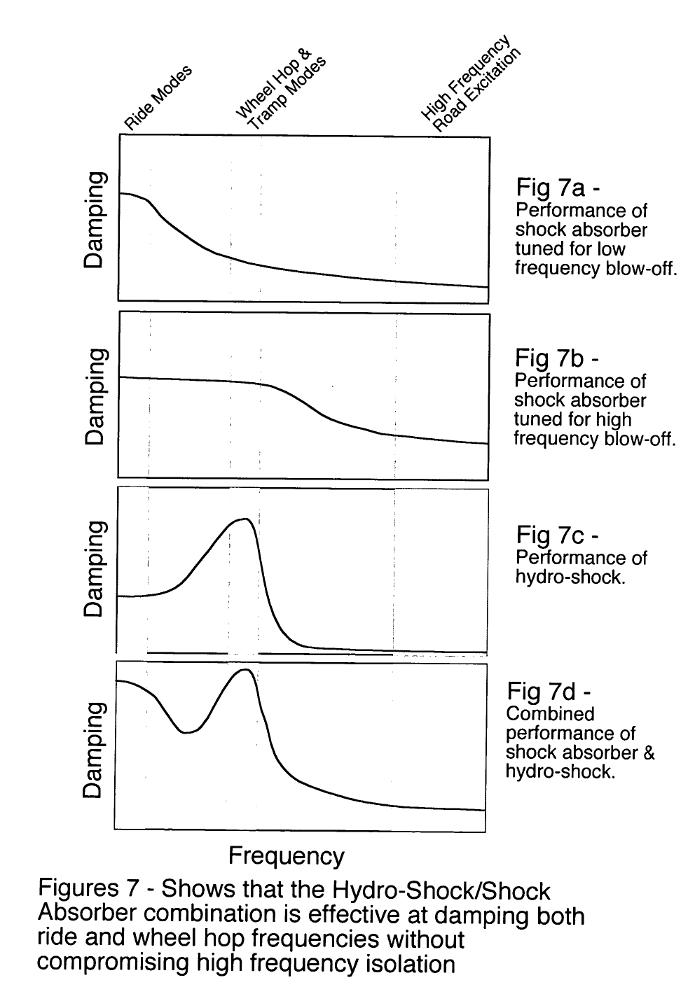

FIGS. 7a through 7d show different systems and their damping vs. frequency characteristics. In each of the diagrams, different frequency ranges are shown which are a particular concern. At the low frequency range is the ride mode characteristics typically from 0-2 Hz with the wheel hop and tramp modes shown in a band of about 10-15 Hz. The next band of interest is much higher and has to do with high frequency road excitation and this is found at the right end of the graphs.

FIGS. 7a shows the performance of a shock absorber tuned for low frequency response. A blow off valve is provided such that the shock absorber is primarily operative at the low frequency ranges associated with ride mode. FIG. 7b shows the compromised performance characteristics of a shock absorber tuned for high frequency blow off. In this case, the blow off valve is designed such that the shock absorber provides damping response over a frequency range that includes both the ride mode and the wheel hop and tramp modes. With this system, there is also damping in the frequency range between these two modes.

FIGS. 7c shows the performance of a long stroke hydraulic tuned damper that is designed to have peak damping for the wheel hop and tramp mode. As can be seen, the structure does provide some damping in the low frequency range and provides minimal damping at the high frequency range.

FIG. 7d shows the combined performance of a shock absorber and long stroke hydraulic tuned damper when they are placed in parallel. In this case, the shock absorber is tuned for the low frequency performance as would be typical of the response in FIG. 7a, in combination with the damping associated with the wheel hop and tramp mode of the long stroke hydraulic tuned damper.

FIG. 7d shows the combined performance of the low frequency shock absorber of FIG. 7a in combination with the long stroke hydraulic tuned damper of FIG. 7c. As is evident from the graph, the shock absorbing system has improved performance at the frequencies of the wheel hop mode and has improved performance relative to the shock absorber tuned for high frequency blow off regarding the high frequency road excitation. Thus, the present system provides the desired performance for ride modes, wheel hop and tramp modes, and higher frequency road noise.

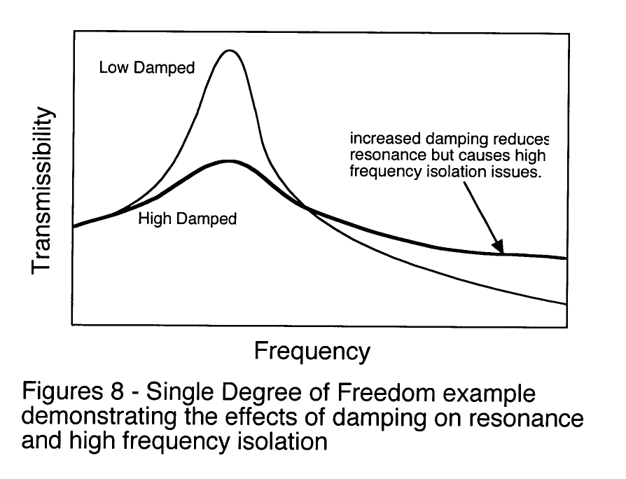

FIG. 8 shows a shock absorbing system that has a higher frequency blow off valve relative to a shock absorber designed with a low frequency blow off valve. In the high frequency blow off valve structure, the curve is labeled high damped. This arrangement causes high frequency transmission issues that are of concern with respect to road noise, etc. The shock absorber with the low frequency blow off valve is shown as low damped and this shock absorber has better performance with respect to higher frequency energy transmission. The combined system having a low frequency blow off valve and a long stroke hydraulic tuned damper provides a compromise between these two designs and has fairly good characteristics with respect to high frequency isolation similar to the low damp response.

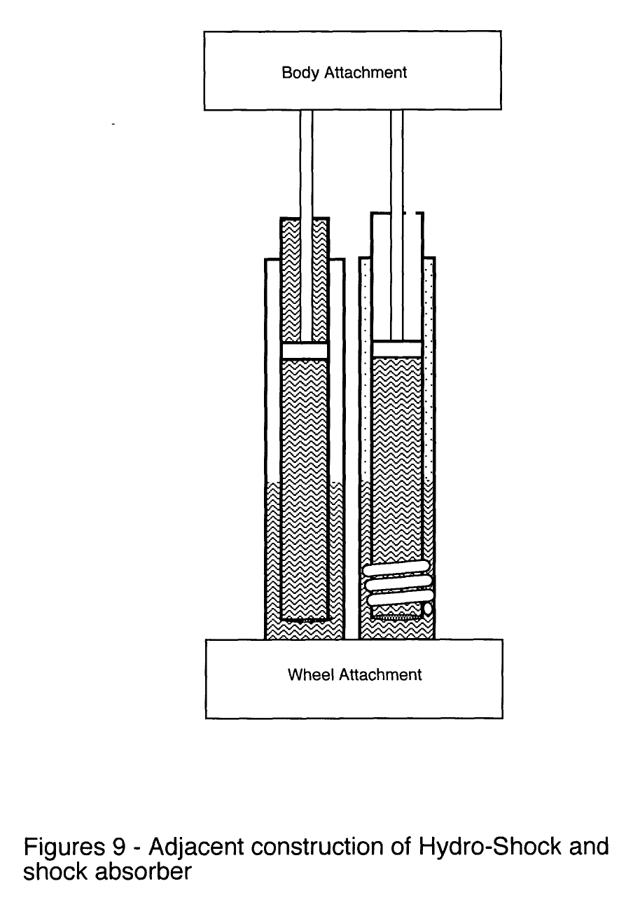

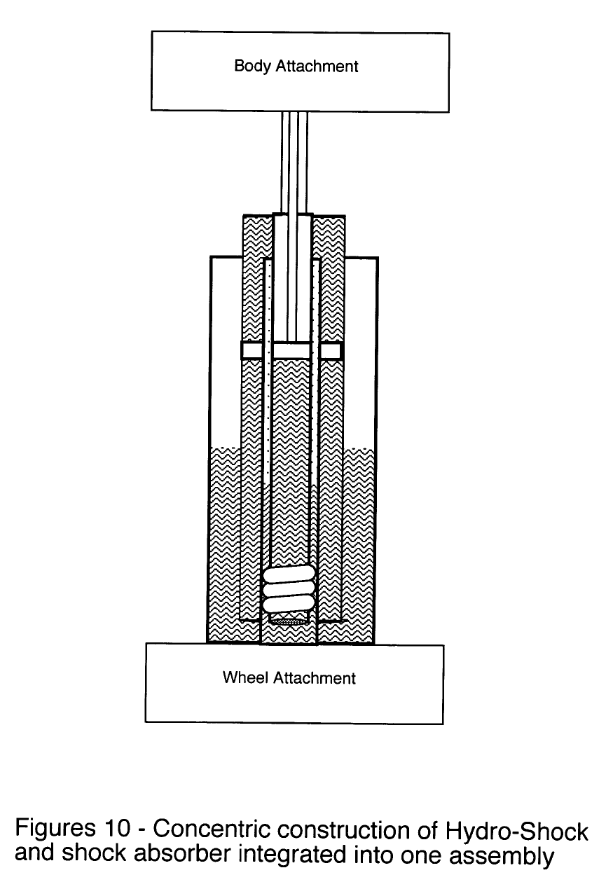

FIGS. 9 and 10 show the vehicle wheel suspension arrangement in two different forms and for clarity the suspension spring (56) has not been shown. In the embodiment of FIG. 9, the two part long stroke hydraulic damping system, i.e., the traditional shock absorber in combination with the long stroke hydraulic tuned damper, are placed in a side by side parallel relationship between the wheel and the vehicle attachment points. Each of these systems is basically operating independently, although they are marginally influenced by the response of the other.

In the embodiment of FIG. 10, the shock absorber and the long stroke hydraulic tuned damper are in a common structure with one system mounted concentrically about the other system. The systems effectively work independently but have been combined in a single housing.

Other arrangements for combining these systems to provide the desired response at two or more frequency bands are possible.

With the systems as shown in FIGS. 4, 5, 6a, 6b, 9, and 10 it is possible to use the single vehicle suspension spring for returning the dampers to appropriate position. Thus, the common spring acts for both the shock absorber and the long stroke hydraulic tuned damper.

For some vehicle applications, the damping provided by the long stroke hydraulic tuned damper will be sufficient to address both the ride mode and the wheel hop and tramp modes. This can be appreciated from a review of FIG. 7c where a significant amount of damping occurs in the low-end frequency range.

It is also possible with this design to employ technologies found in existing hydromounts such as multiple inertia tracks, floating diaphragms, high damped diaphragms, etc., which allow the designer to tailor the stiffness frequency curve of the damper.

With the long stroke hydraulic tuned damper, it is possible to have the device operate to provide significant damping at the wheel hop and/or tramp frequencies while adding little damping to the suspension at frequencies above the tuned frequency. This is clearly shown in FIG. 7c. The significant damping provided by the tuned damper is sufficient to control wheel hop and tramp energy, thereby reducing road induced shake and removing the need for other components to be tuned to attenuate shake which can compromise their primary function. In particular, the powertrain mounts can be optimized for powertrain isolation and powertrain motion control. Hydraulic powertrain mounts if desired can be for powertrain requirements.

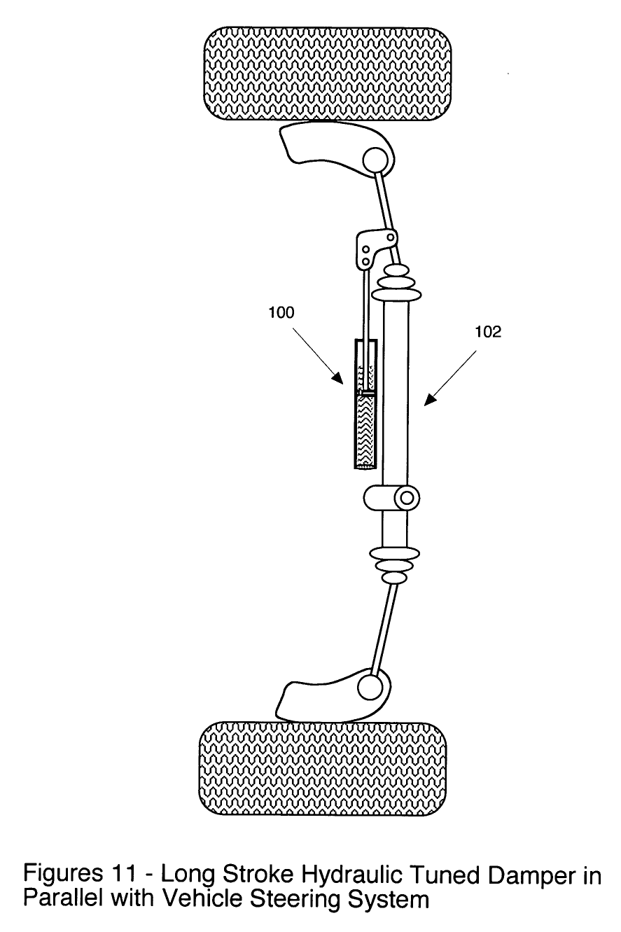

FIG. 11 shows a vehicle steering system arrangement in which the long stroke hydraulic tuned damper (100) is disposed in parallel with the existing vehicle steering gear (102). Suspension modes can transmit energy through the steering system and result in oscillating rotational motion of the steering wheel called “steering nibble”. The long stroke hydraulic tuned damper can attenuate energy at the nibble frequency without degrading performance at other frequencies. Traditional viscous damping devices have been tried for this application, but their broad frequency band damping causes steering feel issues at low frequencies and vibration transmission at higher frequencies.

The long stroke hydraulic tuned damper utilizes a piston and cylinder design rather than the traditional molded rubber shoulder design used in existing technology. This design differs functionally from the existing technology in that the main rubber elements of a traditional hydromount functions as both a piston and a spring. In the present design, the suspension spring provides all the necessary stiffness so that the long stroke hydraulic tuned damper does not need to provide a static stiffness effect.

The piston and cylinder design creates a sliding condition that is not present in a traditional hydromount. This sliding condition may use a working fluid other than the water-glycol mixture used in traditional hydromounts to provide adequate lubrication. The working fluid used in current shock absorber designs has proven itself through many miles and years of use and can be used in the long stroke hydraulic tuned damper application. Other fluids may also be utilized which have different properties and lubrications through viscosity, density, etc. The working cylinder is open to the atmosphere at the top through the vent. This prevents large vacuum of pressure fluctuations from occurring in the uppermost chamber of the working cylinder as the piston moves back and forth. The piston seals prevent fluid from leaking past the piston cylinder interface.

Various forms of inertia track have been shown. The spiral design provided near the base of the operating cylinder is effective and is space efficient. All of the inertia tracks have by definition, an area of Aᵢ and a length Lᵢ. The diaphragm provided at the base of the working cylinder has by definition, an area A_{d} and is made of a compliant material. The other side of the diaphragm is in contact with the collection chamber (FIG. 5). The diaphragm does not need to be capable of handling large fluid displacements, since large displacements occur at relatively low frequencies and the fluid is able to move through inertia track at a rate that is sufficient to prevent excessive pressure build ups. The collection chamber is large enough to hold all of the fluid in the working chamber, even when the piston is at the bottom of the working cylinder, while still providing some additional space that is filled with a low-pressure gas. This low-pressure gas acts as a bellows diaphragm in a traditional hydromount, in that its function is to accommodate the volume change of the fluid flowing to the collection chamber.

In the long stroke hydraulic tuned damper it can be appreciated the amount of fluid displaced in the inner cylinder is equal to the area of the piston times the distance that the piston moves. The hydraulic fluid is assumed to be incompressible.

At low frequencies, the displaced fluid volume flows through the inertia track and into the collection cylinder. This occurs for large amplitude displacements as well as small amplitude displacements.

The cross sectional area of the piston is large with respect to the cross sectional area of the inertia track. Therefore, a unit displacement of the piston requires a much larger displacement of fluid through the inertia track. The movement of fluid through the inertia track is increased with respect to the movement of the piston. This scaling effect makes the few grams of the fluid in the inertia track appear to have a mass of many hundreds or thousands times larger. The gain is equal to
system effective mass=((Area of Piston)/(Area of Inertia Track))²×actual fluid mass

At high frequencies, the inertial effects become quite large and the acceleration and therefore the displacement of the fluid in the inertia track approaches zero. A flexible diaphragm at the bottom of the working cylinder allows the effective mass in the inertia track to decouple from the moving piston. The volume change that accompanies the piston movement is taken up by deflection of the diaphragm. The deflecting diaphragm adds high frequency stiffness to the system. The area of the diaphragm may or may not be equivalent to the area of the piston, so that there may be a scaling effect as there was with the inertia track. The diaphragm introduces a gain that is equal to
system effective stiffness=((Area of Piston)/(Area of Diaphragm))²×diaphragm stiffness

The diaphragm can only accommodate small volume changes. This is not an issue since at high frequencies, where diaphragm motion is necessary, the displacements are quite small. At low frequencies where displacements are high, the fluid moves through the inertia track and the diaphragm is not significantly deflected.

At a certain frequency, the effective mass of the fluid in the inertia track resonates on the effective stiffness of the diaphragm. This resonant frequency is designed to occur at or around the vehicle's suspension wheel hop and/or tramp frequency. As the effective mass transitions from in-phase from out-of-phase motion, the device generates an enormous amount of effective damping. This damping can be used to attenuate the suspension mode of interest.

Reference to “long stroke” in describing the damping system of the present invention is made in comparison to hydromount systems that have small displacements less than 20 mm and often less than 10 mm. Hydromount displacement is limited because hydromounts rely on the stretching of elastomeric material to accommodate deflection. The piston cylinder tunable system of the present invention is designed to accommodate displacement greater than 10 mm and preferably greater than 100 mm. Large displacements are possible due to the sliding piston and cylinder structure. This sliding piston and cylinder hydraulic tuned damper can provide primarily damping if desired or can be used with an internal or external spring to additionally provide static stiffness. In a linkage application, one connector is associated with the piston and a second connector is associated with the cylinder.

Although various preferred embodiments of the present invention have been described herein in detail, it will be appreciated by those skilled in the art, that variations may be made thereto without departing from the spirit of the invention or the scope of the appended claims.

1. A vehicle wheel suspension arrangement comprising a first long stroke vibration damping system and a second long stroke vibration damping system where each long stroke system is tuned to operate at different frequencies; said first long stroke vibration damping system is tuned to attenuate low frequencies associated with a ride mode; said second long stroke vibration damping system is tuned to attenuate higher frequencies associated with a wheel hop and tramp mode and wherein each long stroke vibration damping system is specifically designed to operate over a limited frequency band associated with the specific mode.

2. A vehicle wheel suspension arrangement as claimed in claim 1 wherein said first long stroke vibration damping system includes a blow off valve limiting the attenuation characteristics to a frequency less than 5 hertz.

3. A vehicle wheel suspension arrangement as claimed in claim 1 or 2 wherein said first and second long stroke vibration damping systems are placed in parallel.

4. A vehicle wheel suspension arrangement as claimed in claim 1, 2 or 3 wherein said second long stroke vibration damping system is designed to attenuate frequencies in the range of 10 to 25 hertz.

5. A vehicle wheel suspension arrangement as claimed in claim 1, 2 or 3 wherein each long stroke vibration damping system is designed to be effective in a limited frequency band and said frequency bands are separate and distinct.

6. A vehicle wheel suspension support arrangement as claimed in claim 1, 2, 3, 4 or 5 wherein said long stroke vibration damping systems are disposed in parallel.

7. A vehicle wheel suspension support arrangement as claimed in claim 1, 2, 3, 4, 5 or 6 wherein said second long stroke vibration damping system is a long stroke hydromount type arrangement.

8. A vehicle suspension arrangement as claimed in claim 7 wherein said hydromount arrangement includes an elongated piston cylinder closed at one end by a deformable diaphragm, a piston movable within said cylinder and defining within said cylinder a variable volume working chamber between said piston and said diaphragm, an inertia track connecting said working chamber to a collection chamber, and a working hydraulic fluid which is displaced through said inertia track with movement of said piston.

9. A vehicle suspension arrangement as claimed in claim 1, 2, 3, 4, 5, 6, or 7 wherein said second long stroke vibration damping system accommodates movement of a displaceable member thereof of at least 100 mm.

10. A vehicle wheel suspension arrangement as claimed in claim 1 wherein said first and second vibration damping systems are combined in a single structure with said vibration damping systems being generally concentric.

11. A vehicle wheel suspension arrangement as claimed in claim 1 wherein said first and second vibration damping systems are combined and disposed in a parallel configuration.

12. A vehicle wheel suspension arrangement as claimed in claim 1 wherein said first and second vibration damping systems are integrated into a combined vibration damping system.

13. A vehicle wheel suspension arrangement as claimed in claim 1 wherein said limited frequency band associated with ride mode is separated from said frequency band associated with wheel hop and tramp mode by an intermediate frequency band.

14. A vehicle wheel suspension arrangement as claimed in claim 13 wherein said first and second vibration damping systems have limited influence on vibrations of a frequency within said intermediate frequency band and said suspension arrangement has improved performance with respect to road noise.

15. A vehicle wheel suspension arrangement as claimed in claim 1, wherein said first and second systems cooperate to reduce high frequency damping associated with road noise.

16. In a vehicle wheel suspension arrangement, a vibration damping system comprising a first vibration damping transmission path for attenuating vibrations of a frequency associated with a ride mode and a second vibration damping transmission path for attenuating vibrations of a frequency associated with a wheel hop and tramp mode; and wherein each vibration damping transmission path is designed to be effective in attenuating frequencies and accommodating displacements of the associated mode.

17. In a vehicle suspension arrangement as claimed in claim 16 wherein said vibration transmission path functions in a parallel manner.

18. In a vehicle suspension arrangement as claimed in claim 16 wherein said vibration transmission paths are integrated.

19. A hydraulic tuned damper comprising an elongate piston cylinder closed at one end by a deformable diaphragm, a piston movable within said cylinder and defining between said piston and said deformable diaphragm, a variable volume working chamber, an inertia track connecting said working chamber with a collection chamber, and a working hydraulic fluid which is displaced through said inertia track between said working chamber and said collection chamber with movement of said piston.

20. A hydraulic tuned damper as claimed in claim 19 wherein said damper is used in a steering linkage and is tuned to reduced steering nibble.
